(19) United States
(12) Patent Application Publication
(10) Pub. No.: US 2016/0063988 A1
(43) Pub. Date: Mar. 3, 2016

(54) OVERSIGHT CONTROL OF AN ADAPTIVE NOISE CANCELER IN A PERSONAL AUDIO DEVICE

(71) Applicant: Cirrus Logic, Inc., Austin, TX (US)

(72) Inventors: Jon D. Hendrix, Wimberly, TX (US); Ali Abdollahzadeh Milani, Austin, TX (US); Nitin Kwatra, Austin, TX (US); Dayong Zhou, Austin, TX (US); Yang Lu, Cedar Park, TX (US); Jeffrey Alderson, Austin, TX (US)

(21) Appl. No.: 14/840,831

(22) Filed: Aug. 31, 2015

Related U.S. Application Data
(63) Continuation of application No. 13/309,494, filed on Dec. 1, 2011, now Pat. No. 9,142,207.
(60) Provisional application No. 61/419,527, filed on Dec. 3, 2010.
(60) Provisional application No. 61/493,162, filed on Jun. 3, 2011.

(51) Int. Cl. G10K 11/178; H04R 1/10

(52) U.S. Cl. CPC G10K 11/1784; G10K 11/1788; H04R 1/1083; G10K 2210/1081; G10K 2210/3216; G10K 2210/3226; G10K 2210/504; H04R 2460/01; H04R 2499/11

(57) ABSTRACT

A personal audio device, such as a wireless telephone, includes an adaptive noise canceling (ANC) circuit that adaptively generates an anti-noise signal from a reference microphone signal and injects the anti-noise signal into the speaker or other transducer output to cause cancellation of ambient audio sounds. An error microphone is also provided proximate the speaker to measure the ambient sounds and transducer output near the transducer, thus providing an indication of the effectiveness of the noise canceling. A processing circuit uses the reference and/or error microphone, optionally along with a microphone provided for capturing near-end speech, to determine whether the ANC circuit is incorrectly adapting or may incorrectly adapt to the instant acoustic environment and/or whether the anti-noise signal may be incorrect and/or disruptive and then take action in the processing circuit to prevent or remedy such conditions.

This U.S. patent application is a Continuation of U.S. patent application Ser. No. 13/309,494 filed on Dec. 1, 2011 and published as U.S. Patent Publication 20120140943 on Jun. 7, 2012, and claims priority thereto under 35 U.S.C. 120. U.S. patent application Ser. No. 13/309,494 claims priority under 35 U.S.C. 119(e) to U.S. Provisional Patent Application Ser. No. 61/419,527 filed on Dec. 3, 2010 and to U.S. Provisional Patent Application Ser. No. 61/493,162 filed on Jun. 3, 2011.

### BACKGROUND OF THE INVENTION

1. Field of the Invention

The present invention relates generally to personal audio devices such as wireless telephones that include adaptive noise cancellation (ANC), and more specifically, to management of ANC in a personal audio device under various operating conditions.

2. Background of the Invention

Wireless telephones, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events.

Since the acoustic environment around personal audio devices such as wireless telephones can change dramatically, depending on the sources of noise that are present and the position of the device itself, it is desirable to adapt the noise canceling to take into account such environmental changes. However, adaptive noise canceling circuits can be complex, consume additional power and can generate undesirable results under certain circumstances.

Therefore, it would be desirable to provide a personal audio device, including a wireless telephone, that provides noise cancellation in a variable acoustic environment.

### SUMMARY OF THE INVENTION

The above stated objective of providing a personal audio device providing noise cancellation in a variable acoustic environment, is accomplished in a personal audio device, a method of operation, and an integrated circuit.

The personal audio device includes a housing, with a transducer mounted on the housing for reproducing an audio signal that includes both source audio for playback to a listener and an anti-noise signal for countering the effects of ambient audio sounds in an acoustic output of the transducer, which may include the integrated circuit to provide adaptive noise-canceling (ANC) functionality. The method is a method of operation of the personal audio device and integrated circuit. A reference microphone is mounted on the housing to provide a reference microphone signal indicative of the ambient audio sounds. The personal audio device further includes an ANC processing circuit within the housing for adaptively generating an anti-noise signal from the reference microphone signal using one or more adaptive filters, such that the anti-noise signal causes substantial cancellation of the ambient audio sounds. An error microphone is included for controlling the adaptation of the anti-noise signal to cancel the ambient audio sounds and for correcting for the electro-acoustic path from the output of the processing circuit through the transducer.

By analyzing the audio received from the reference and error microphone, the ANC processing circuit can be controlled in accordance with types of ambient audio that are present. Under certain circumstances, the ANC processing circuit may not be able to generate an anti-noise signal that will cause effective cancellation of the ambient audio sounds, e.g., the transducer cannot produce such a response, or the proper anti-noise cannot be determined. Certain conditions may also cause the adaptive filter(s) to exhibit chaotic or other uncontrolled behavior. The ANC processing circuit of the present invention detects such conditions and takes action on the adaptive filter(s) to reduce the impact of such events and to prevent an erroneous anti-noise signal from being generated.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is an illustration of a wireless telephone 10 in accordance with an embodiment of the present invention.

FIG. 2 is a block diagram of circuits within wireless telephone 10 in accordance with an embodiment of the present invention.

FIG. 3 is a block diagram depicting signal processing circuits and functional blocks within ANC circuit 30 of CODEC integrated circuit 20 of FIG. 2 in accordance with an embodiment of the present invention.

FIG. 4 is a block diagram illustrating functional blocks associated with ambient audio event detection and ANC control in the circuit of FIG. 3 in accordance with an embodiment of the present invention.

FIG. 5 is a flowchart of a method of determining that the ANC operation is likely to generate undesirable anti-noise or adapt improperly and taking appropriate action, in accordance with an embodiment of the present invention.

FIG. 6 is a block diagram depicting signal processing circuits and functional blocks within an integrated circuit in accordance with an embodiment of the present invention.

### DESCRIPTION OF ILLUSTRATIVE EMBODIMENT

The present invention encompasses noise canceling techniques and circuits that can be implemented in a personal audio device, such as a wireless telephone. The personal audio device includes an adaptive noise canceling (ANC) circuit that measures the ambient acoustic environment and generates a signal that is injected in the speaker (or other transducer) output to cancel ambient acoustic events. A reference microphone is provided to measure the ambient acoustic environment and an error microphone is included for controlling the adaptation of the anti-noise signal to cancel the ambient audio sounds and for correcting for the electro-acoustic path from the output of the processing circuit through the transducer. However, under certain acoustic conditions, e.g., when a particular acoustic condition or event occurs, the ANC circuit may operate improperly or in an unstable/chaotic manner. The present invention provides mechanisms for preventing and/or minimizing the impact of such conditions.

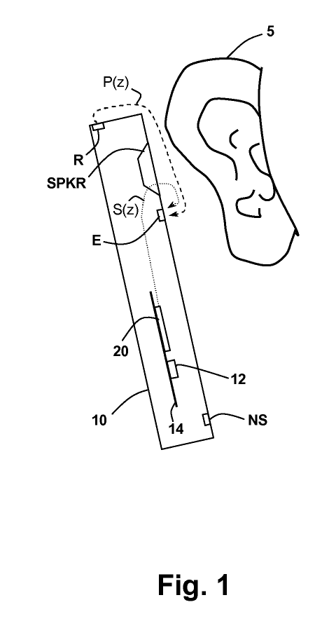

Referring now to FIG. 1, a wireless telephone 10 is illustrated in accordance with an embodiment of the present invention is shown in proximity to a human ear 5. Illustrated wireless telephone 10 is an example of a device in which techniques in accordance with embodiments of the invention may be employed, but it is understood that not all of the elements or configurations embodied in illustrated wireless telephone 10, or in the circuits depicted in subsequent illustrations, are required in order to practice the invention recited in the Claims. Wireless telephone 10 includes a transducer, such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from web-pages or other network communications received by wireless telephone 10 and audio indications such as battery low and other system event notifications. A near-speech microphone NS is provided to capture near-end speech, which is transmitted from wireless telephone 10 to the other conversation participant(s).

Wireless telephone 10 includes adaptive noise canceling (ANC) circuits and features that inject an anti-noise signal into speaker SPKR to improve intelligibility of the distant speech and other audio reproduced by speaker SPKR. A reference microphone R is provided for measuring the ambient acoustic environment, and is positioned away from the typical position of a user's mouth, so that the near-end speech is minimized in the signal produced by reference microphone R. A third microphone, error microphone E, is provided in order to further improve the ANC operation by providing a measure of the ambient audio combined with the audio reproduced by speaker SPKR close to ear 5, when wireless telephone 10 is in close proximity to ear 5. Exemplary circuit 14 within wireless telephone 10 includes an audio CODEC integrated circuit 20 that receives the signals from reference microphone R, near speech microphone NS and error microphone E and interfaces with other integrated circuits such as an RF integrated circuit 12 containing the wireless telephone transceiver. In other embodiments of the invention, the circuits and techniques disclosed herein may be incorporated in a single integrated circuit that contains control circuits and other functionality for implementing the entirety of the personal audio device, such as an MP3 player-on-a-chip integrated circuit.

In general, the ANC techniques of the present invention measure ambient acoustic events (as opposed to the output of speaker SPKR and/or the near-end speech) impinging on reference microphone R, and by also measuring the same ambient acoustic events impinging on error microphone E, the ANC processing circuits of illustrated wireless telephone 10 adapt an anti-noise signal generated from the output of reference microphone R to have a characteristic that minimizes the amplitude of the ambient acoustic events at error microphone E. Since acoustic path P(z) extends from reference microphone R to error microphone E, the ANC circuits are essentially estimating acoustic path P(z) combined with removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which is affected by the proximity and structure of ear 5 and other physical objects and human head structures that may be in proximity to wireless telephone 10, when wireless telephone is not firmly pressed to ear 5. While the illustrated wireless telephone 10 includes a two microphone ANC system with a third near speech microphone NS, some aspects of the present invention may be practiced in a system that does not include separate error and reference microphones, or a wireless telephone uses near speech microphone NS to perform the function of the reference microphone R. Also, in personal audio devices designed only for audio playback, near speech microphone NS will generally not be included, and the near-speech signal paths in the circuits described in further detail below can be omitted, without changing the scope of the invention, other than to limit the options provided for input to the microphone covering detection schemes.

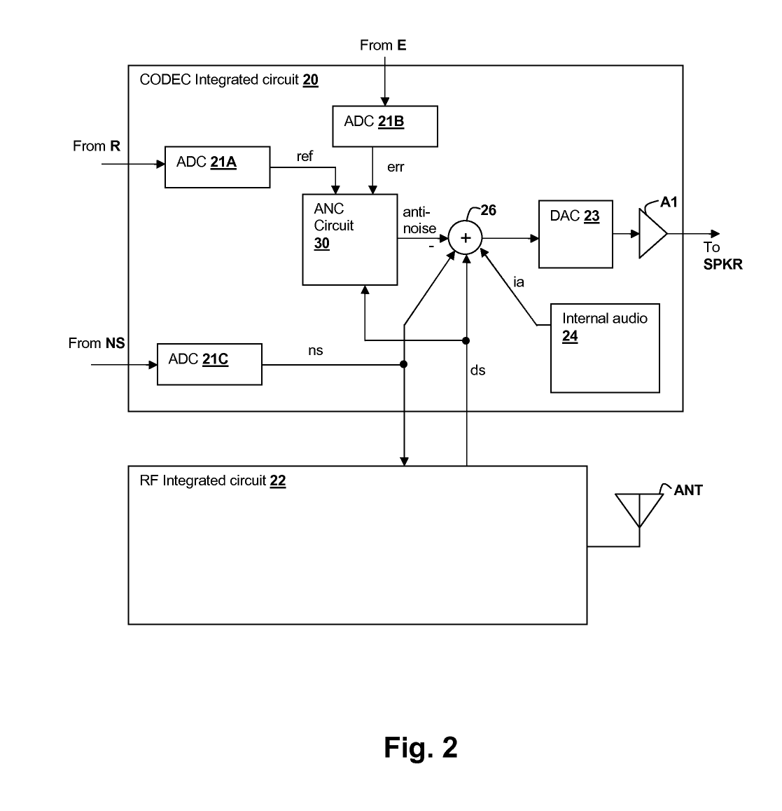

Referring now to FIG. 2, circuits within wireless telephone 10 are shown in a block diagram. CODEC integrated circuit 20 includes an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the error microphone signal. CODEC IC 20 generates an output for driving speaker SPKR from an amplifier A1, which amplifies the output of a digital-to-analog converter (DAC) 23 that receives the output of a combiner 26. Combiner 26 combines audio signals from internal audio sources 24, the anti-noise signal generated by ANC circuit 30, which by convention has the same polarity as the noise in reference microphone signal ref and is therefore subtracted by combiner 26, a portion of near speech signal ns so that the user of wireless telephone 10 hears their own voice in proper relation to downlink speech ds, which is received from radio frequency (RF) integrated circuit 22 and is also combined by combiner 26. Near speech signal ns is also provided to RF integrated circuit 22 and is transmitted as uplink speech to the service provider via antenna ANT.

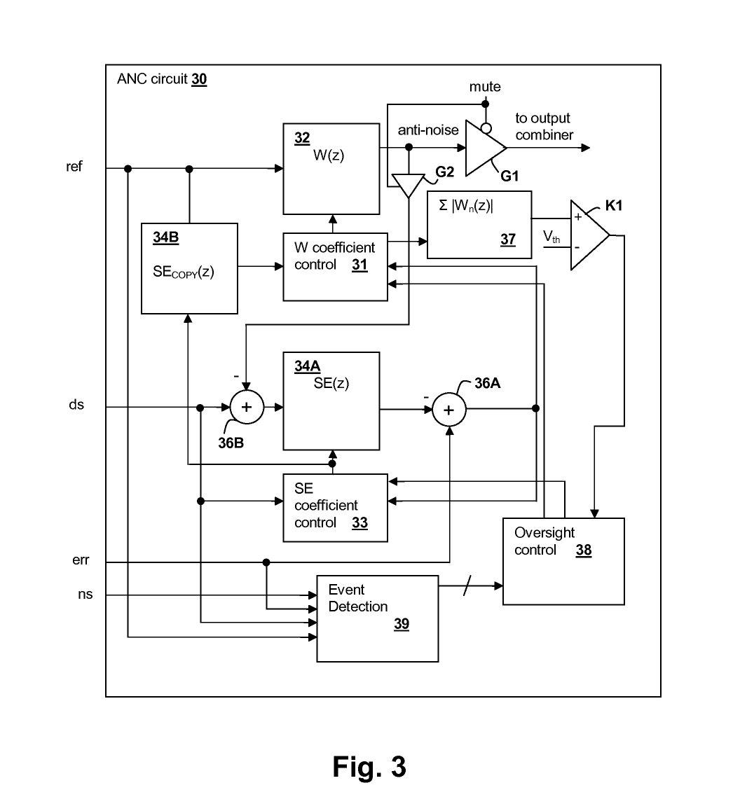

Referring now to FIG. 3, details of ANC circuit 30 are shown in accordance with an embodiment of the present invention. Adaptive filter 32 receives reference microphone signal ref and under ideal circumstances, adapts its transfer function W(z) to be P(z)/S(z) to generate the anti-noise signal, which is provided to an output combiner that combines the anti-noise signal with the audio to be reproduced by the transducer, as exemplified by combiner 26 of FIG. 2. A muting gate circuit G1 mutes the anti-noise signal under certain conditions as described in further detail below, when the anti-noise signal is expected to be erroneous or ineffective. In accordance with some embodiments of the invention, another gate circuit G2 controls re-direction of the anti-noise signal into a combiner 36B that provides an input signal to secondary path adaptive filter 34A, permitting W(z) to continue to adapt while the anti-noise signal is muted during certain ambient acoustic conditions as described below. The coefficients of adaptive filter 32 are controlled by a W coefficient control block 31 that uses a correlation of two signals to determine the response of adaptive filter 32, which generally minimizes the error, in a least-mean squares sense, between those components of reference microphone signal ref present in error microphone signal err. The signals compared by W coefficient control block 31 are the reference microphone signal ref as shaped by a copy of an estimate of the response of path S(z) provided by filter 34B and another signal that includes error microphone signal err. By transforming reference microphone signal ref with a copy of the estimate of the response of path S(z), SE_{copy}(z), and minimizing the difference between the resultant signal and error microphone signal err, adaptive filter 32 adapts to the desired response of P(z)/S(z). In addition to error microphone signal err, the signal compared to the output of filter 34B by W coefficient control block 31 includes an inverted amount of downlink audio signal ds that has been processed by filter response SE(z), of which response SE_{copy}(z) is a copy. By injecting an inverted amount of downlink audio signal ds, adaptive filter 32 is prevented from adapting to the relatively large amount of downlink audio present in error microphone signal err, and by transforming that inverted copy of downlink audio signal ds with the estimate of the response of path S(z), the downlink audio that is removed from error microphone signal err before comparison should match the expected version of downlink audio signal ds reproduced at error microphone signal err, since the electrical and acoustical path of S(z) is the path taken by downlink audio signal ds to arrive at error microphone E. Filter 34B is not an adaptive filter, per se, but has an adjustable response that is tuned to match the response of adaptive filter 34A, so that the response of filter 34B tracks the adapting of adaptive filter 34A.

To implement the above, adaptive filter 34A has coefficients controlled by SE coefficient control block 33, which compares downlink audio signal ds and error microphone signal err after removal of the above-described filtered downlink audio signal ds, that has been filtered by adaptive filter 34A to represent the expected downlink audio delivered to error microphone E, and which is removed from the output of adaptive filter 34A by a combiner 36A. SE coefficient control block 33 correlates the actual downlink speech signal ds with the components of downlink audio signal ds that are present in error microphone signal err. Adaptive filter 34A is thereby adapted to generate a signal from downlink audio signal ds (and optionally, the anti-noise signal combined by combiner 36B during muting conditions as described above), that when subtracted from error microphone signal err, contains the content of error microphone signal err that is not due to downlink audio signal ds. Event detection 39 and oversight control logic 38 perform various actions in response to various events in conformity with various embodiments of the invention, as will be disclosed in further detail below.

Table 1 below depicts a list of ambient audio events or conditions that may occur in the environment of wireless telephone 10 of FIG. 1, the issues that arise with the ANC operation, and the responses taken by the ANC processing circuits when the particular ambient events or conditions are detected.

TABLE I

| Type of Ambient | | | |
|---|---|---|---|
| Audio Condition or | | | |
| Event | Cause | Issue | Response |
| Mechanical Noise at | Wind, Scratching, etc. | Unstable anti-noise, | Mute anti-noise |
| Microphone or | | ineffective cancelation | Stop adapt W(z) |
| instability of the | | | Reset W(z) |
| coefficients of W(z) in | | | Optional 1: |
| general | | | Stop adapt SE(z) |
| | | | Reset/Backtrack SE(z) |
| | | | Alternative: |
| | | | Mute anti-noise |
| | | | Redirect anti-noise |
| | | | into SE(z) |
| Howling | Positive feedback | Anti-noise generates | Mute anti-noise |
| | caused by | undesirable tone | Stop adapt W(z) |
| | increased | | Stop adapt SE(z) |
| | acoustic coupling | | Reset W(z) |
| | between transducer | | Optional: |
| | and reference | | Reset/Backtrack SE(z) |
| | microphone | | |
| Overloading noise | SPL too high | Clipping of signals in | Stop adapt W(z) |
| | | ANC circuit or | Optionally mute |
| | | transducer can't | anti-noise |
| | | produce enough output | Optional: |
| | | to cancel | stop adapting SE(s) |
| | | | reset/backtrack SE(z) |
| Silence | Quiet Environment | No reason to ANC, | Stop adapt W(z) |
| | | nothing to adapt to. | Optionally mute |
| | | | anti-noise |
| Tone | Multiple | Disrupts response of | Stop adapt W(z) |
| | | W(z) | |
| Near-end speech | User talking | Don't want to train to | Stop adapt W(z) |
| | | cancel near end speech | or increase leakage |
| Source audio too low | Downlink audio silent, | Insufficient level to | Stop adapt SE(z) |
| | or playback of media | train SE(z) | |
| | stops | | |

As illustrated in FIG. 3, W coefficient control block 31 provides the coefficient information to a computation block 37 that computes the time derivative of the sum Σ|Wₙ(z)| of the magnitudes of the coefficients Wₙ(z) that shape the response of adaptive filter 32, which is an indication of the variation overall gain of the response of adaptive filter 32. Large variations in sum Σ|Wₙ(z)| indicate that mechanical noise such as that produced by wind incident on reference microphone R or varying mechanical contact (e.g., scratching) on the housing of wireless telephone 10, or other conditions such as an adaptation step size that is too large and causes unstable operation has been used in the system. A comparator K1 compares the time derivative of sum Σ|Wₙ(z)| to a threshold to provide an indication to oversight control 38 of a mechanical noise condition, which may be qualified with a detection by event detection 39, whether there are large changes in the energy of near-end speech signal ns that could indicate that the variation in sum Σ|Wₙ(z)| is due to variation in the energy of near-end speech present at wireless telephone 10.

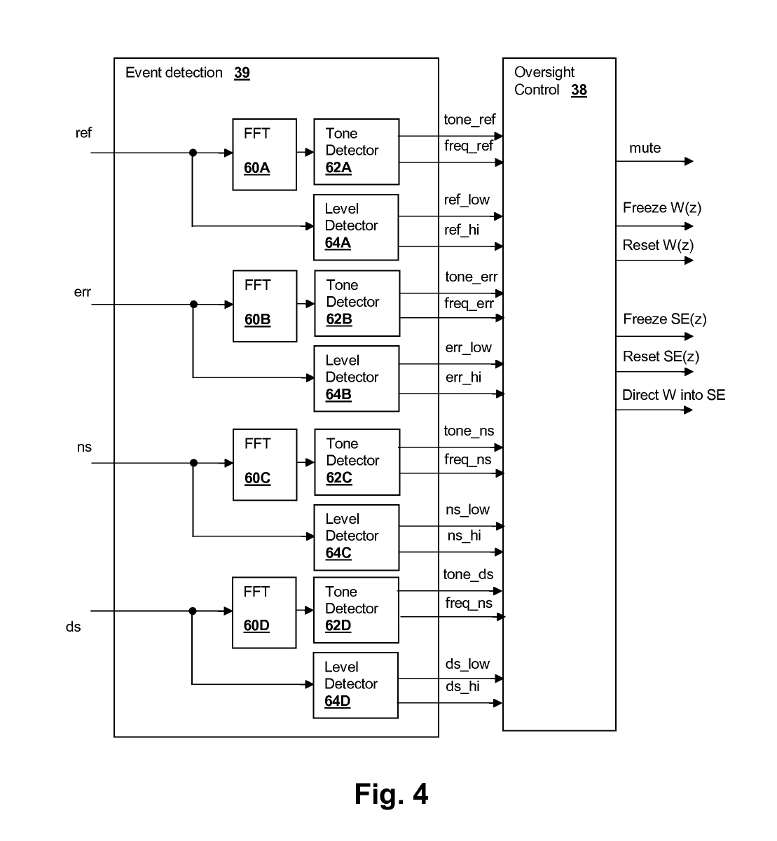

Referring now to FIG. 4, details within event detection circuit 39 of FIG. 3 are shown, in accordance with an embodiment of the present invention. Each of reference microphone signal ref, error microphone signal err, near speech signal ns, and downlink speech ds are provided to corresponding FFT processing blocks 60A-60D, respectively. Corresponding tone detectors 62A-62D receive the outputs from their corresponding FFT processing blocks 60A-60D and generate flags (tone_ref, tone_err, tone_ns and tone_ds) that indicate the presence or absence of a consistent well-defined peak in the spectrum of the input signal that indicates the presence of a tone. Tone detectors 62A-62D also provide an indication of the frequency of the detected tone (freq_ref, freq_err, freq_ns and freq_ds). Each of reference microphone signal ref, error microphone signal err, near speech signal ns, and downlink speech ds are also provided to corresponding level detectors 64A-64D, respectively, that generate an indication (ref_low, err_low, ns_low, ds_low) when the level of the corresponding input signal level drops below a predetermined lower limit and another indication (ref_hi, err_hi, ns_hi, ds_hi) when the corresponding input signal exceeds a predetermined upper limit. With the information generated by event detector 39, oversight control 38 can determine whether a strong tone is present, including howling due to positive feedback between the transducer and reference microphone ref, as may be caused by cupping a hand between the transducer and the reference microphone ref, and take appropriate action within the ANC processing circuits. Howling is detected by determining that a tone is present at each of the microphone inputs (i.e., tone_ref, tone_err and tone_ns are all set), that the frequencies of the tone are all equal (freq_ref=freq_err=freq_ns) and the levels of the bin of the fundamental bin of the tone is greater in error microphone channel err than in the reference microphone channel ref and the speech channel ns by corresponding thresholds, and that the err_freq value is not equal to ds_freq, which would indicate that the tone is coming from downlink speech ds and should be reproduced. Oversight control 38 can also distinguish other types of tones that may be present and take other actions. Oversight control 38 also monitors the reference microphone signal level indications, ref_low and ref_hi, to determine whether overloading noise is present or the ambient environment is silent, near speech level indication ns_hi, which indicates that near speech is present, and downlink audio level indication ds_low to determine whether downlink audio is absent. Each of the above-listed conditions corresponds to a row in Table I, and oversight control takes the appropriate action, as listed, when the particular condition is detected.

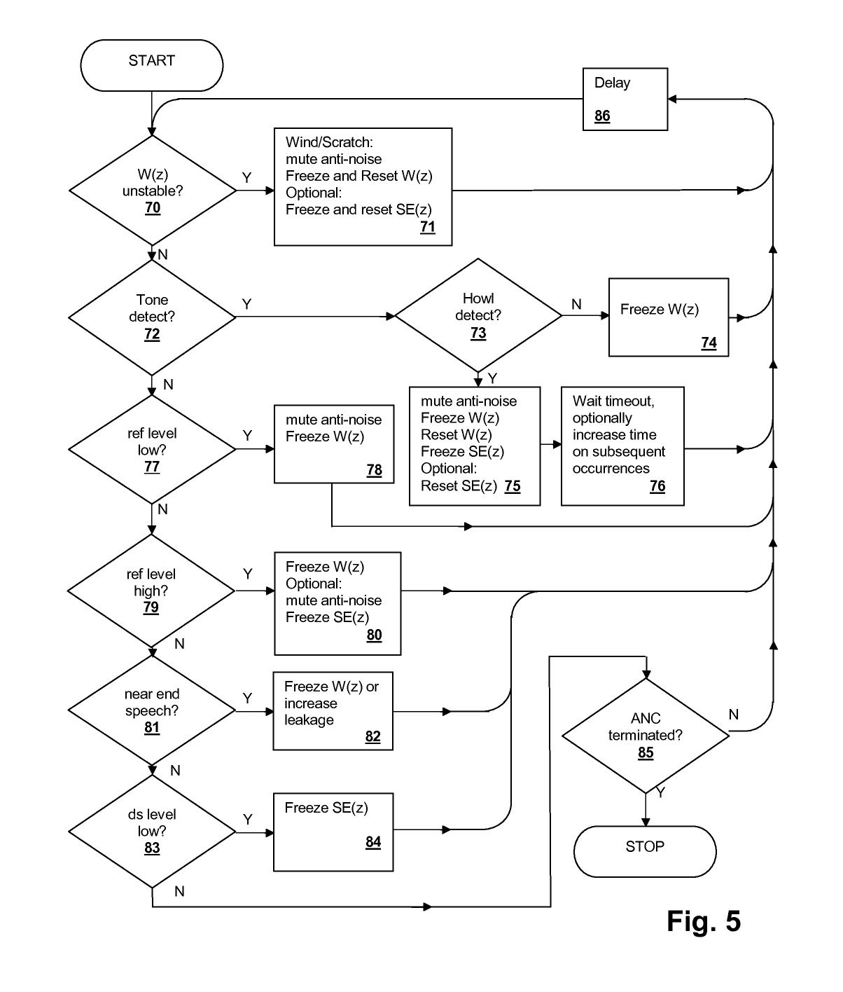

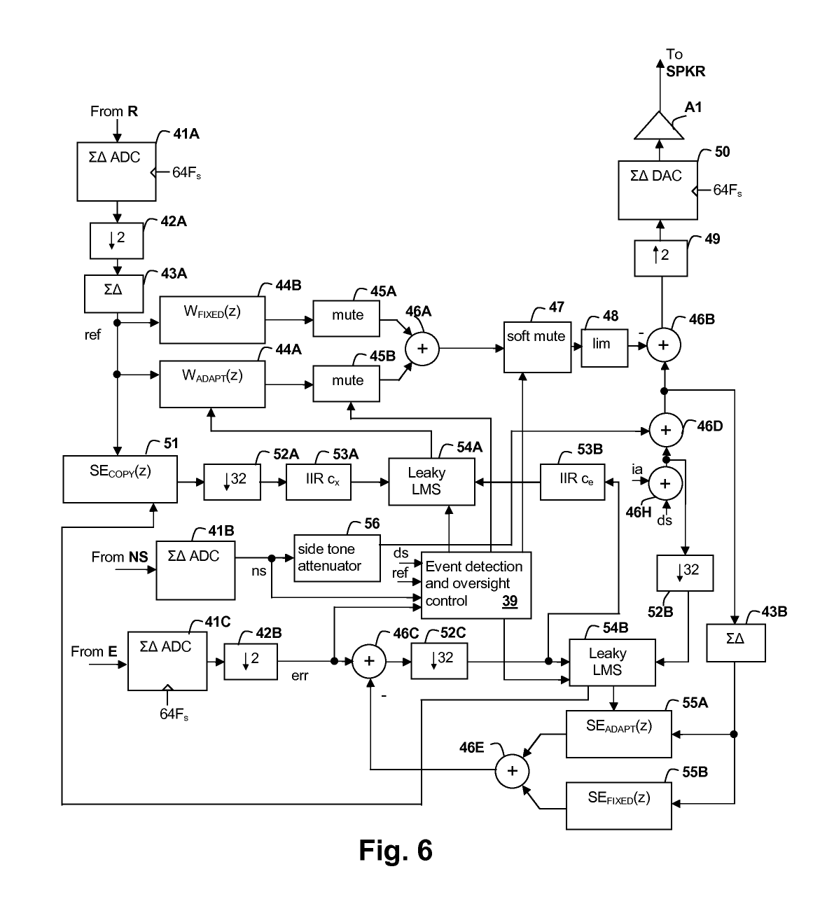

Referring now to FIG. 5, an oversight control algorithm is illustrated, in accordance with an embodiment of the present invention. If the adaptation of filter response W(z), i.e. the control of the values of the coefficients of filter response W(z), is determined to be unstable (decision 70), then the anti-noise is muted and filter response W(z) is reset and frozen from further adapting (step 71). Response SE(z) is optionally reset and frozen, as well. Alternatively, as mentioned above, rather than freezing adaptation of response W(z), the anti-noise signal can be re-directed into adaptive filter 34A. If a tone is detected (decision 72) and the positive feedback howling condition is indicated (decision 73), then the anti-noise is muted, responses W(z) and SE(z) are frozen from further adapting, response W(z) is reset and response SE(z) is optionally reset, as well (step 75). A wait time out is employed and may be increased for subsequent iterations (step 76). Otherwise, if a tone is detected (decision 72) and the howling condition is not indicated (decision 73), then response W(z) is frozen (step 74). If the reference microphone level is low (ref_low set) (decision 77), then anti-noise is muted and response W(z) is frozen from further adapting (step 78). If the reference microphone level is high (ref_hi set) (decision 79), then response W(z) is frozen from further adapting or the leakage of the adaptive filter is increased (step 78). Leakage in a parallel adaptive filter arrangement is described below with reference to FIG. 6. If the level of reference microphone channel ref is too high (ref_hi is set) (decision 79), then responses W(z) and SE(z) are frozen from further adapting and optionally, the anti-noise signal is muted (step 80). If near end speech is detected (ns_high is set) (decision 81), then response W(z) is either frozen from further adapting, or the leakage amount is increased (step 82). If the downlink audio ds level is low (ds_low is set), then response SE(z) is frozen from further adapting (step 84), since there is no downlink audio signal to which response SE(z) can train. Until the ANC processing is terminated (step 85), the process in steps 70-85 is repeated, with an additional delay 86 that permits the action to have time to react to, and in some cases stop, an undesirable condition that is detected by the algorithm illustrated in FIG. 5.

Referring now to FIG. 6, a block diagram of an ANC system is shown for illustrating ANC techniques in accordance with an embodiment of the invention, as may be implemented within CODEC integrated circuit 20. Reference microphone signal ref is generated by a delta-sigma ADC 41A that operates at 64 times oversampling and the output of which is decimated by a factor of two by a decimator 42A to yield a 32 times oversampled signal. A delta-sigma shaper 43A spreads the energy of images outside of bands in which a resultant response of a parallel pair of filter stages 44A and 44B will have significant response. Filter stage 44B has a fixed response W_{FIXED}(z) that is generally predetermined to provide a starting point at the estimate of P(z)/S(z) for the particular design of wireless telephone 10 for a typical user. An adaptive portion W_{ADAPT}(z) of the response of the estimate of P(z)/S(z) is provided by adaptive filter stage 44A, which is controlled by a leaky least-means-squared (LMS) coefficient controller 54A. Leaky LMS coefficient controller 54A is leaky in that the response normalizes to flat or otherwise predetermined response over time when no error input is provided to cause leaky LMS coefficient controller 54A to adapt. Providing a leaky controller prevents long-term instabilities that might arise under certain environmental conditions, and in general makes the system more robust against particular sensitivities of the ANC response. An exemplary leakage control equation is given by:

Wₖ₊₁=(1−Γ)·Wₖ+μ·eₖ·Xₖ

where μ=2^{-normalzed}^{_{—}}^{stepsize} and normalized_stepsize is a control value to control the step between each increment of k, Γ=2^{-normalized}^{_{—}}^{leakage}, where normalized_leakage is a control value that determines the amount of leakage, eₖ is the magnitude of the error signal, Xₖ is the magnitude of the reference microphone signal ref, Wₖ is the starting magnitude of the amplitude response of filter 44A and Wₖ₊₁ is the updated value of the magnitude of the amplitude response of filter 44A. As mentioned above, increasing the leakage of LMS coefficient controller 54A can be performed when near-end speech is detected, so that the anti-noise signal is eventually generated from the fixed response, until the near-end speech has ended and the adaptive filter can again adapt to cancel the ambient environment at the listener's ear.

In the system depicted in FIG. 6, the reference microphone signal is filtered by a copy SE_{copy}(z) of the estimate of the response of path S(z), by a filter 51 that has a response SE_{copy}(z), the output of which is decimated by a factor of 32 by a decimator 52A to yield a baseband audio signal that is provided, through an infinite impulse response (IIR) filter 53A to leaky LMS 54A. Filter 51 is not an adaptive filter, per se, but has an adjustable response that is tuned to match the combined response of filters 55A and 55B, so that the response of filter 51 tracks the adapting of SE(z). The error microphone signal err is generated by a delta-sigma ADC 41C that operates at 64 times oversampling and the output of which is decimated by a factor of two by a decimator 42B to yield a 32 times oversampled signal. As in the system of FIG. 3, an amount of downlink audio ds that has been filtered by an adaptive filter to apply response S(z) is removed from error microphone signal err by a combiner 46C, the output of which is decimated by a factor of 32 by a decimator 52C to yield a baseband audio signal that is provided, through an infinite impulse response (IIR) filter 53B to leaky LMS 54A. Response S(z) is produced by another parallel set of filter stages 55A and 55B, one of which, filter stage 55B has fixed response SE_{FIXED}(z), and the other of which, filter stage 55A has an adaptive response SE_{ADAPT}(z) controlled by leaky LMS coefficient controller 54B. The outputs of filter stages 55A and 55B are combined by a combiner 46E. Similar to the implementation of filter response W(z) described above, response SE_{FIXED}(z) is generally a predetermined response known to provide a suitable starting point under various operating conditions for electrical/acoustical path S(z). Filter 51 is a copy of adaptive filter 55A/55B, but is not itself an adaptive filter, i.e., filter 51 does not separately adapt in response to its own output, and filter 51 can be implemented using a single stage or a dual stage. A separate control value is provided in the system of FIG. 6 to control the response of filter 51, which is shown as a single adaptive filter stage. However, filter 51 could alternatively be implemented using two parallel stages and the same control value used to control adaptive filter stage 55A could then be used to control the adjustable filter portion in the implementation of filter 51. The inputs to leaky LMS control block 54B are also at baseband, provided by decimating a combination of downlink audio signal ds and internal audio ia, generated by a combiner 46H, by a decimator 52B that decimates by a factor of 32, and another input is provided by decimating the output of a combiner 46C that has removed the signal generated from the combined outputs of adaptive filter stage 55A and filter stage 55B that are combined by another combiner 46E. The output of combiner 46C represents error microphone signal err with the components due to downlink audio signal ds removed, which is provided to LMS control block 54B after decimation by decimator 52C. The other input to LMS control block 54B is the baseband signal produced by decimator 52B.

The above arrangement of baseband and oversampled signaling provides for simplified control and reduced power consumed in the adaptive control blocks, such as leaky LMS controllers 54A and 54B, while providing the tap flexibility afforded by implementing adaptive filter stages 44A-44B, 55A-55B and filter 51 at the oversampled rates. The remainder of the system of FIG. 6 includes combiner 46H that combines downlink audio ds with internal audio ia, the output of which is provided to the input of a combiner 46D that adds a portion of near-end microphone signal ns that has been generated by sigma-delta ADC 41B and filtered by a sidetone attenuator 56 to prevent feedback conditions. The output of combiner 46D is shaped by a sigma-delta shaper 43B that provides inputs to filter stages 55A and 55B that has been shaped to shift images outside of bands where filter stages 55A and 55B will have significant response.

In accordance with an embodiment of the invention, the output of combiner 46D is also combined with the output of adaptive filter stages 44A-44B that have been processed by a control chain that includes a corresponding hard mute block 45A, 45B for each of the filter stages, a combiner 46A that combines the outputs of hard mute blocks 45A, 45B, a soft mute 47 and then a soft limiter 48 to produce the anti-noise signal that is subtracted by a combiner 46B with the source audio output of combiner 46D. The output of combiner 46B is interpolated up by a factor of two by an interpolator 49 and then reproduced by a sigma-delta DAC 50 operated at the 64× oversampling rate. The output of DAC 50 is provided to amplifier A1, which generates the signal delivered to speaker SPKR.

Each or some of the elements in the system of FIG. 6, as well as in the exemplary circuits of FIG. 2 and FIG. 3, can be implemented directly in logic, or by a processor such as a digital signal processing (DSP) core executing program instructions that perform operations such as the adaptive filtering and LMS coefficient computations. While the DAC and ADC stages are generally implemented with dedicated mixed-signal circuits, the architecture of the ANC system of the present invention will generally lend itself to a hybrid approach in which logic may be, for example, used in the highly oversampled sections of the design, while program code or microcode-driven processing elements are chosen for the more complex, but lower rate operations such as computing the taps for the adaptive filters and/or responding to detected events such as those described herein.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A personal audio device, comprising:
a personal audio device housing;
a transducer mounted on the housing for reproducing an audio signal including both source audio for playback to a listener and an anti-noise signal for countering the effects of ambient audio sounds in an acoustic output of the transducer;
a reference microphone mounted on the housing for providing a reference microphone signal indicative of the ambient audio sounds;
an error microphone mounted on the housing in proximity to the transducer for providing an error microphone signal indicative of the acoustic output of the transducer and the ambient audio sounds at the transducer; and
a processing circuit that implements at least one adaptive filter having a response that generates the anti-noise signal from the reference signal to reduce the presence of the ambient audio sounds heard by the listener, wherein the processing circuit implements a coefficient control block that shapes the response of the at least one adaptive filter in conformity with the error microphone signal and the reference microphone signal by computing coefficients that determine the response of the adaptive filter to minimize the ambient audio sounds at the error microphone, and wherein the processing circuit detects that an ambient audio event is occurring that could cause the adaptive filter to generate an undesirable component in the anti-noise signal and changes the adapting of the at least one adaptive filter independent of the computing of the coefficients by the coefficient control block, wherein the ambient audio event is wind noise, scratching on the housing of the personal audio device, a substantially tonal ambient sound, or a signal level of the reference microphone signal falling outside of a predetermined range.

2. The personal audio device of claim 1, wherein the processing circuit changes the adaptation of the adaptive filter by halting the adaptation of the at least one of the adaptive filter.

3. The personal audio device of claim 1, wherein the processing circuit mutes the anti-noise signal during the ambient audio event.

4. The personal audio device of claim 1, wherein the processing circuit sets one or more coefficients of the at least one adaptive filter to a predetermined value to remedy disruption of the adapting of the response of the at least one adaptive filter by the ambient audio event.

5. The personal audio device of claim 1, wherein the ambient audio event is a level of the reference microphone signal falling outside of a predetermined range.

6. The personal audio device of claim 1, wherein the ambient audio event is substantially tonal.

7. The personal audio device of claim 1, wherein the ambient audio event is near-end speech.

8. A method of canceling ambient audio sounds in the proximity of a transducer of a personal audio device, the method comprising:
first measuring ambient audio sounds with a reference microphone to produce a reference microphone signal;
second measuring an output of the transducer and the ambient audio sounds at the transducer with an error microphone;
adaptively generating an anti-noise signal by computing coefficients that control a response of an adaptive filter from a result of the first measuring and the second measuring for countering the effects of ambient audio sounds at an acoustic output of the transducer by adapting the response of the adaptive filter, wherein the adaptive filter filters an output of the reference microphone to generate the anti-noise signal;
combining the anti-noise signal with a source audio signal to generate an audio signal provided to the transducer;
detecting that an ambient audio event is occurring that could cause the adaptive filter to generate an undesirable component in the anti-noise signal independent of the computing of the coefficients, wherein the ambient audio event is wind noise, scratching on a housing of the personal audio device, a substantially tonal ambient sound, or a signal level of the reference microphone signal falling outside of a predetermined range; and
responsive to the detecting, changing the adapting of the at least one adaptive filter.

9. The method of claim 8, wherein the changing changes the adaptation of the adaptive filter by halting the adaptation of the at least one of the adaptive filter.

10. The method of claim 8, further comprising muting the anti-noise signal during the ambient audio event.

11. The method of claim 8, wherein the changing sets one or more coefficients of the at least one adaptive filter to a predetermined value to remedy disruption of the adapting of the response of the at least one adaptive filter by the ambient audio event.

12. The method of claim 8, wherein the ambient audio event is a level of the reference microphone signal falling outside of a predetermined range.

13. The method of claim 8, wherein the ambient audio event is substantially tonal.

14. The method of claim 8, wherein the ambient audio event is near-end speech.

15. An integrated circuit for implementing at least a portion of a personal audio device, comprising:
an output for providing a signal to a transducer including both source audio for playback to a listener and an anti-noise signal for countering the effects of ambient audio sounds in an acoustic output of the transducer;
a reference microphone input for receiving a reference microphone signal indicative of the ambient audio sounds;
an error microphone input for receiving an error microphone signal indicative of the output of the transducer and the ambient audio sounds at the transducer; and
a processing circuit that implements at least one adaptive filter having a response that generates the anti-noise signal from the reference signal to reduce the presence of the ambient audio sounds heard by the listener, wherein the processing circuit implements a coefficient control block that shapes the response of the at least one adaptive filter in conformity with the error microphone signal and the reference microphone signal by computing coefficients that determine the response of the adaptive filter to minimize the ambient audio sounds at the error microphone, and wherein the processing circuit detects that an ambient audio event is occurring that could cause the adaptive filter to generate an undesirable component in the anti-noise signal and changes the adapting of the at least one adaptive filter independent of the computing of the coefficients by the coefficient control block, wherein the ambient audio event is wind noise, scratching on a housing of the personal audio device, a substantially tonal ambient sound, or a signal level of the reference microphone signal falling outside of a predetermined range.

16. The integrated circuit of claim 15, wherein the processing circuit changes the adaptation of the adaptive filter by halting the adaptation of the at least one of the adaptive filter.

17. The integrated circuit of claim 15, wherein the processing circuit mutes the anti-noise signal during the ambient audio event.

18. The integrated circuit of claim 15, wherein the processing circuit sets one or more coefficients of the at least one adaptive filter to a predetermined value to remedy disruption of the adapting of the response of the at least one adaptive filter by the ambient audio event.

19. The integrated circuit of claim 15, wherein the ambient audio event is a level of the reference microphone signal falling outside of a predetermined range.

20. The integrated circuit of claim 15, wherein the ambient audio event is substantially tonal.

21. The integrated circuit of claim 15, wherein the ambient audio event is near-end speech.
